(19) United States
(12) Patent Application Publication
(10) Pub. No.: US 2022/0198391 A1
(43) Pub. Date: Jun. 23, 2022

(54) SUPPLY CHAIN MANAGEMENT SYSTEM AND PLATFORM

(71) Applicant: Target Brands, Inc., Minneapolis, MN (US)

(72) Inventors: Michael Rorro, Minneapolis, MN (US); Bryce Cooks, Minneapolis, MN (US); Anne Plaisted, Minneapolis, MN (US); Anthony Louis Russo, III, Minneapolis, MN (US); Anthony Bradley Pluth, Minneapolis, MN (US); Nikita Vasant Solanki, Minneapolis, MN (US); Erin Cassidy Mozdy, Minneapolis, MN (US)

(21) Appl. No.: 17/126,683

(22) Filed: Dec. 18, 2020

(51) Int. Cl. G06Q 10/08; G06Q 10/06; G06Q 10/10; G06F 16/2455

(52) U.S. Cl. CPC G06Q 10/0875; G06Q 10/06314; G06Q 10/0833; G06Q 10/0838; G06Q 10/06315; G06F 16/2455; G06Q 10/1093

(57) ABSTRACT

An inventory readiness date is received that specifies a first calendar date on which an order of items should be ready at each items' respective destination location. For each item of the order, an arrival date before the readiness date is determined, the arrival date specifying a second calendar date on which the item should arrive at the item's respective destination location. A departure date before the arrival date is determined, the departure date specifying a third calendar date on which the item should depart the item's respective source location. For each item of the order, an inventory readiness metric is determined based on the item's travel based on tracking data for the item as the item travels from the item's respective source location to the respective destination location.

### TECHNICAL FIELD

This document generally relates to technology for supply chain management, including technology for tracking freight in transit through a supply chain.

### BACKGROUND

Supply chains are, in general, complex networks through which goods are supplied from producers to retailers and, ultimately, consumers. For example, supply chains can involve many different producers that are generating products for distribution, each of which may emanate from multiple different production and/or distribution facilities. These products can be transported using any of a variety of carriers, such as trucks, railcars, and/or boats, and in many instances may involve using multiple different carriers as items are transported through the supply chain (e.g., boat for transport over ocean, rail to transport from port to distribution center, and truck from distribution center to retail store). Additionally, items may be processed through one or more distribution center before they ultimately are delivered to retail stores and/or directly to consumers. As a result, supply chains can generate large numbers of data records, such as data identifying items and carriers that are transporting the items.

Supply chain tracking and management systems have included features to simply present the data records associated with the supply chain. For example, supply chain management systems have provided users with the ability to view a current data record for an item in the supply chain as well as an ability to view a historical log of data records for the item.

### SUMMARY

The disclosed technology is generally directed to supply chain management systems and platforms to better and more accurately track and assess the state of the supply chain, including determining inventory readiness metrics which indicate whether loads and orders are on schedule for delivery to distribution centers by a target date. The supply chain management systems and platforms build off of and uses inventory ready dates (IRD) for items in the supply chain, which can be the date on which items will arrive at and be available for distribution at a distribution center (e.g., inventory unloaded from truck and available within distribution center for redistribution to, for instance, retail store or direct customer shipment). The IRD can be a singular target date that different actors and users of the supply chain can unify around, such as buyers, suppliers, distributors, carriers, and retailers. Previously, these different actors may have each had their own target dates and deadlines, which may have looked at only their smaller portion of the supply chain without broader supply chain considerations. IRD can be a unified target date against which all actors within the supply chain can organize and unify their activities around, with the ultimate goal being the holistic improvement and satisfaction of the supply chain's objectives—to supply requested items to distributors and retailers to meet demand for the items. IRD can take into account each leg of the supply chain, combining logistics, inventory management, and field operations to ensure that the IRD is accurate.

The disclosed supply chain management systems and platforms can use the IRD to track the status of the supply chain and to manage the allocation of resources, such as prioritizing shipments that have fallen behind their target IRD. The disclosed supply chain management systems and platforms can also provide visualization tools that can be used to visualize the supply chain and its contents, and to manage the supply chain.

To provide these features, which help to provide improve tracking, management, and assessment of the supply chain, including understanding changes over time to the state of the supply chain (as well as projected future states of the supply chain), the disclosed technology can use any of a variety of components, such as a load tracker which tracks the status of loads (e.g., trucks, trains) that are transporting goods to distribution centers; an order tracker which builds off of the load tracker to track the status of orders that are (often) being fulfilled across multiple loads; and user interface features that use the load tracker and the order tracker to visualize and assess the current status of the supply chain, including visualizing individual loads/orders as well as broader swaths of the supply chain. These components can track and assess supply chain features against IRDs, and these components can be combined to better determine, monitor, and assess the status of the supply chain.

In some implementations, a system can be used for the management of data. The system includes one or more processors. The system includes computer-readable memory. The computer-readable memory stores instructions that, when executed by the processors, cause the processors to perform operations include receiving an inventory readiness date that specifies a first calendar date on which an order of items should be ready at each items' respective destination location. The operations further include determining, for each item of the order, an arrival date before the readiness date, the arrival date specifying a second calendar date on which the item should arrive at the item's respective destination location. The operations further include determining, for each item of the order, a departure date before the arrival date, the departure date specifying a third calendar date on which the item should depart the item's respective source location. The operations further include generating, for each item of the order, an inventory readiness metric based on the item's travel based on tracking data for the item as the item travels from the item's respective source location to the respective destination location.

Implementations can include some, none, or all of the following features. Determining, for each item of the order, an arrival date and determining, for each item of the order, a departure date, comprises querying a user for the second calendar date and the third calendar date. Generating, for each item, an inventory readiness metric comprises: receiving tracking data from a plurality of shipping containers, each shipping container containing at least one of the items; determining, for each item, the item's inventory readiness metric by comparing the tracking data of the shipping container containing the item to at least one of the group consisting of i) the item's arrival date; and ii) the items departure date. The operations further comprise: generating, for the order of items, a first multi-factor metric that represents the inventory readiness metric of each item of the order; and presenting, to a user of the system, a graphical representation of the first multi-factor metric. The operations further comprise generating, for a container containing items of the order as well as items of other orders, a second multi-factor metric that represents the inventory readiness metric of each item contained by the container; and presenting, to a user of the system, a graphical representation of the second multi-factor metric. A single item of the order of items contributes the same status to the first multi-factor metric and to the second multi-factor metric. The operations further comprise updating the inventory readiness metrics as updated tracking data is received. A difference between the first calendar date and the second calendar date is determined based on capabilities of the destination location for the item. A difference between the second calendar date and the third calendar date is determined based on capabilities of a shipping duration for a container of the item.

The systems, devices, program products, and processes described throughout this document can, in some instances, provide one or more of the following advantages. For example, given the magnitude of supply chain data, it can be challenging to determine the current status and state of the supply chain (e.g., on track, behind schedule, ahead of schedule). The disclosed technology provides improved solutions, over convention supply chain management systems and platforms, in that it is able to simplify this problem and provide a comprehensive solution that can permit for tracking and assessing the supply chain at a variety of different levels of granularity (e.g., load level, distribution center level, retail store department level). For instance, through the use of load tracking and order tracking, which can build on load tracking results, can be used to generate inventory readiness metrics (e.g., ahead of schedule, behind schedule, on track relative to IRD) across multiple different dimensions, including across loads (e.g., trucks, boats, trains) and across orders (e.g., purchase order placed with vendors).

In another example, the disclosed technology can improve supply chain management. For instance, complex orders made of hundreds, thousands, or millions of items can be tracked to create metrics that are far more simple than the raw tracking data, while still providing a viewer with enough information to understand the status of the order. This technology can be used for orders that will be supplied from many sources, to be sent to many destinations, by many different types of cargo haulers.

### DESCRIPTION OF DRAWINGS

FIG. 1 shows a diagram of a system for generating inventory readiness metrics.

FIG. 2 shows a flowchart of a process of generating inventory readiness metrics.

FIGS. 3 and 4 show schematic diagrams of an example readiness metric.

FIG. 5 shows a diagram of a system for generating inventory readiness metrics.

FIG. 6 shows a flowchart of a process for tracking inventory readiness metrics for a container of items.

FIG. 7 shows a flowchart of an example process for tracking inventory readiness metrics for an order of items.

FIG. 8 is a schematic diagram that shows an example of a computing device and a mobile computing device.

Like reference symbols in the various drawings indicate like elements

### DETAILED DESCRIPTION

As described above, this document describes a technology platform for accurate tacking and assessing of the state of the supply chain, including whether loads and the orders they are on schedule for delivery to distribution centers. This technology uses an inventory ready date (IRD) as a key target for inventory shipped to destinations by the supply chain. From the IRD, various other milestone dates can be calculated. Then, orders consisting of hundreds, thousands, or millions of items are created to meet the IRD. From this, intermediate deadlines are created that, if met, make meeting the IRD likely. Metrics can be generated and displayed based on the items meeting or not meeting the deadlines created by this system.

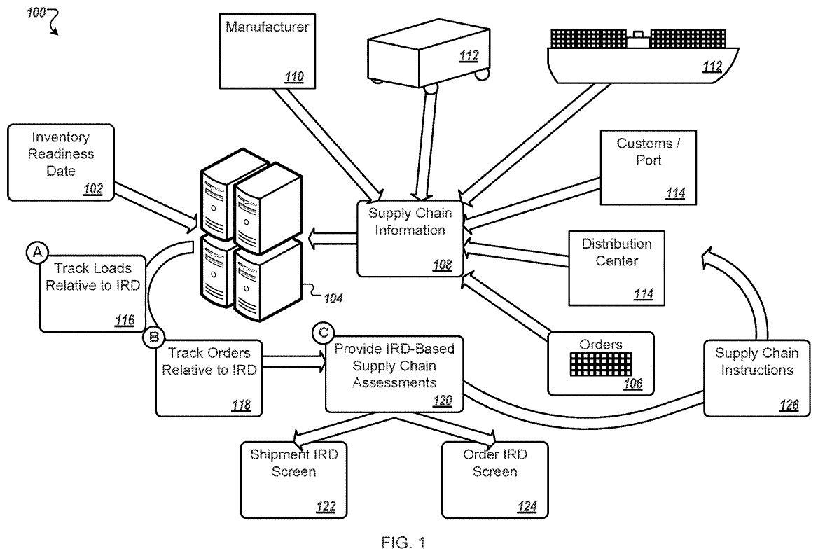

FIG. 1 shows a diagram of a system 100 for generating inventory readiness metrics. In general, an IRD 102 represents the date at which items ordered in a single order should be ready for use in a warehouse, distribution center, store, or other end location. This IRD 102 may be different, and later, than the day the items arrive at the distribution center. For example, if it takes 24 hours to unload a truck, unpack boxes, open containers, etc., before the item is sitting on the shelf ready to be accessed, the IRD 102 may be one day later than the day that the item should arrive in the truck at the distribution center.

A supply chain management computer system 104 can receive information for one or more orders 106. The orders 106 may each specify a collection of information. For example, the orders 106 may specify a list of items, a destination for each item (e.g., various stores, distribution centers), a source for each item (e.g., a factory, manufacturer, or other source of the item), price information, and/or handling information (e.g., weight, size, compatible containers). Each order 106 may be matched to an inventory readiness date 102. In this way, a large, multi-facility enterprise may be able to create complex, multi-item, multi-facility orders in a unified process.

To monitor the status of the order (e.g., to help a user understand if the manufacturers and suppliers are shipping the ordered items), the supply chain management computer system 104 can receive supply chain information 108 that contains information about the supply chain that is used to complete the orders 106. For example, the supply chain information 108 can include reporting data from manufacturers 110, including estimated and actual dates of manufacture, dates of shipment, etc. The supply chain information 108 can include reporting data for containers 112, including railcars, container trucks, ships, etc. The reporting data for containers 112 can include scheduling information, location tracking information, route information, etc. The supply chain information 108 can include reporting data from intermediate locations 114, including customs, ports, and distribution centers. In general, these intermediate locations can include locations where items, or containers holding the items, are temporarily held when in transit from their source (e.g., a manufacturer) to their destination (e.g., a fulfilment center). In some cases, the computer system 104 can filter, decorate, or otherwise alter the supply chain information 108 on receipt. For example, a large enterprise may generate a very large amount of data. Of this data, only a portion may be needed, and the unneeded portions may be filtered out. Similarly, the computer system 104 may decorate incoming supply chain information 108. For example, geolocation information may be decorated with the state or country in which the location resides.

The received information may be structured in the form of data events that each record a physical event that occurs in the supply chain. For example, a load arriving at a destination may create an event, a GPS location heartbeat message may be an event, etc. These events may be listened to by various components of the computer system 104 and, upon receipt of a new event, may launch one or more of the processes described in this document. In some cases, events may cause the update to data related to an order or load (e.g., updating location, IRD risk, or other data).

The supply chain management computer system 104 can use the received information 102, and 108 to track loads 116 relative to the IRDs 102. For example, a load in a truck may contain items for five different orders 106. The supply chain management computer system 104 may determine, for each of those five orders, if the truck's estimated arrival date will make that order's items on time, early, or late. The truck may have an estimated arrival date supplied by the trucking company, but this estimated arrival date may be different from the dates needed for IRDs 102 to be on time. For example, a delay up-stream of the shipping at the manufacturer 110 may make an IRD 102 in danger of being missed, even if the shipping by truck is done in an appropriate time. In such a way, a truck may be “on time” according to the trucking company, but the items in the truck may be “on time”, “early”, or “late” according to the IRDs 102. By separating the analysis of a carrier's performance with IRD risk, different and more useful information can be generated by the system. For example, a carrier that happens to receive loads late through no fault of their own (e.g., they service a port that has been experiencing bad weather, delaying unloading of boats) can be seen as performing well even if their loads have high IRD risk. Similarly, a carrier that often has unexpected delays but carries loads with low IRD risk may be seen as performing poorly.

The supply chain management computer system 104 can track 118 orders relative to IRDs 102. For example, with the status of each item in a load relative to IRD 102 known, the supply chain management computer system 104 can aggregate the IRD status of items in a single order across containers. This can include items from multiple sources being shipped to multiple destinations. In such a case, the breakdown of IRD status may not be a single number or value, but may instead be a multi-factor distribution of values. For example, 92% of items in an order may be on time, 5% may be early, and 3% may be late. This may be caused by most trucks carrying the items to different distribution centers carrying on-time items, two trucks carrying moving ahead of schedule, and one truck carrying items being delayed.

The supply chain management computer system 104 can provide 120 IRD-based supply chain assessments. For example, the supply chain management computer system 104 can generate one or more computer screens in the form of HTML web pages, application interfaces, or static reports that report the status of loads relative to IRD 122, orders relative to IRD 124, or in other formats. In addition, the computer system 104 can also use the IRD-based supply chain assessments to update and improve the operations of the supply chain. For example, one or more computer-readable instructions 126 can be generated in order to implement, modify, cancel, and/or otherwise perform various supply chain operations by supply chain actors, such as manufacturers 110, carriers transporting containers 112, distribution centers and ports 114, purchase ordering systems 106, retail stores, and/or other systems and actors that are part of a supply chain. For example, the supply chain assessment 120 can be used to generate supply chain instructions 126 to send to a carrier 112 and/or intermediate location (e.g., port 114, distribution center 114) to expedite a particular load that has many items with high IRD risk. These instructions may be automatically generated and configured to cause one or more systems (e.g., automated systems, a package handling system, truck dispatch system) to perform one or more actions that can reduce the overall IRD risk of the supply chain.

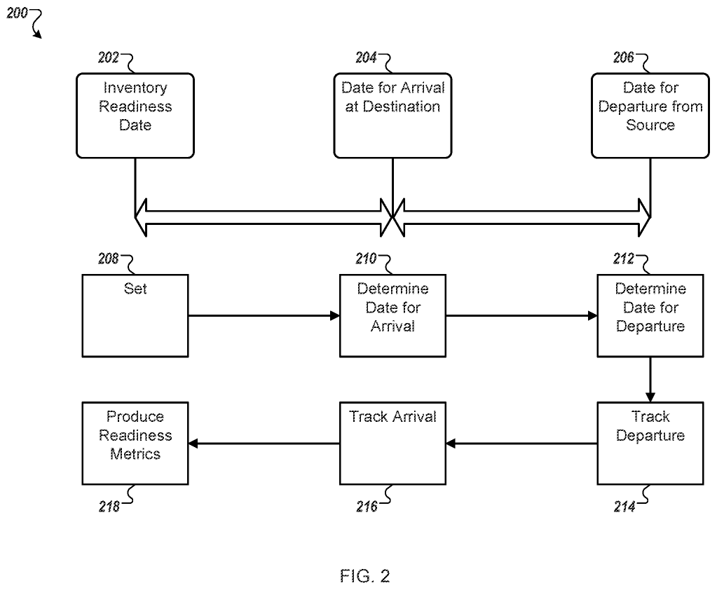

FIG. 2 shows a flowchart of a process 200 of generating inventory readiness metrics. In the process 200, an IRD 102 is set 208, and then from there intermediate dates are determined based on various factors of the supply chain. In general, these intermediate dates act as benchmarks to aid in the evaluation of IRDs 102—if the intermediate dates are being met, the order is likely on time, and if the intermediate dates are not being met, the order is likely to be late.

One intermediate date can be a date for arrival at destination 204, which may include a distribution center, a store, etc. As previously explained, the item may not be ready for use when it initially arrives at its destination. It may need to be unloaded, unpacked, inspected, assembled, and placed on a shelf, etc., before it is available for use. This process may take a significant enough amount of time that i) the process may impact the IRD if it goes slower than normal and ii) the process may be abstracted away without impacting the accuracy of the IRD analysis. For example, an item traveling down a two foot ramp from the back of a shelf to the front may take seconds and be fast enough to not need accounted for, but the unpacking discussed here may involve hours or days of work from arrival at the destination.

One intermediate date can be a date of departure from the item's source 206. This source may in some cases be the location where the item is manufactured, mined, generated, or assembled. In some cases, the source may be the first point at which the supply chain is automatically monitored. For example, a supplier of raw materials may not provide detailed, electronic tracking information until the raw materials arrive at the customs-controlled port where the material is being exported. In such a case, the customs-controlled port may be the source of the item, even if it is hundreds of miles from where the raw material is grown, extracted, manufactured, etc.

Two intermediate dates are shown here, but other intermediate dates can be used, including more or fewer dates. For example, if the items must from the source by rail car, then by ship, then by truck before arrival at the destination, additional intermediate dates may be used to represent the transition from rail to ship, and from ship to truck, as well as additional intermediate dates within each of those modes of transit (e.g., intermediate date for carrier reaching one or more intermediate locations and/or progress points). Additional and/or alternative intermediate dates can include stops in which some, but not all, of a load are unloaded or loaded. For example, a truck may have a load with items destined for two different retail stores, and each arrival and departure from the two retail stores may also have an intermediate date.

An IRD is set 208. For example, a computer system can receive, from outside of the computer system, input that specifies and IRD. This input may take the form of user input entering the data through a graphical user interface (GUI). This input may take the form of a data message transmitted over a data network. The receiving computer system can, using the input, store the IRD to computer memory to specify a first calendar date on which an order of items should be ready at each items' respective destination location. In some cases, the IRD is received as part of input that specifies the order for the computer system.

An arrival date is determined for each item of the order 210. For example, the computer system may access data for each item of the order and identify a destination for that item. For example, the order may specify one million identical items, with ten thousand items being ordered for each of one hundred distribution centers located across a country. Each distribution may have recorded the number of days that the center normally takes to unload and make ready such items—one day, two days, or three days. As such, the computer system may determine arrival dates 204 for each distribution center that are one day, two days, or three days before the IRD 202. As such, for each item of the order, an arrival date is set before the readiness date, the arrival date specifying a second calendar date on which the item should arrive at the item's respective destination location.

A departure date is determined for each item of the order 212. For example, the computer system may access data for each item of the order and identify a source for that item. For example, the items may be shipped from one of three factories spread across the country. Given the source of the item along with the destination now, the computer system can determine a length of time needed to transport the item from the source to the destination. Working backwards from the arrival date 204, the computer system can determine a departure date before the arrival date, the departure date specifying a third calendar date on which the item should depart the item's respective source location. For example, if a particular item has an IRD 202 of Friday, an arrival date 204 of Thursday, and requires two days to transit from the source to the destination, a departure date of Tuesday may be determined.

In some cases, determining, for each item of the order, an arrival date and determining, for each item of the order, a departure date, comprises querying a user for the second calendar date and the third calendar date. For example, the computer system may generate one or more GUIs to provide a user with an order specification screen. The user may input, into the screen, details about the order. This can include the IRD, the arrival date 204, and the departure date. In some implementations, this information may be generated based on secondary considerations input by the user. For example, the user may specify an IRD 202 and request arrival dates and departure dates calculated to reduce transit costs, time in transit, storage overhead, etc. In another example, the user may enter the departure date, as that may be inflexibly set by the manufacturer, and from there the GUI may guide the user to select other aspects of the order (e.g., shipping method or IRD), and the system may proposed values given those inputs (e.g., providing an IRD given the shipping method, providing a recommended shipping method given the IRD).

Events such as departure events are tracked 214 and arrival events are tracked 216. For example, as the items move through the supply chain, the computer system may receive tracking updates of such movement and identify transit events (e.g., departure events, arrival events). Based on these events, the computer system can keep up-to-date of location data for each item. In addition, estimates of future arrivals and/or departures can be updated based on the new information, and these projections can be compared against IRD to determine the risk level for various items (e.g., high risk of item missing IRD based on projected arrival date). For example, if a load arrives to one destination a day early, projected future arrivals and departures may be adjusted by one day to reflect this updated understanding of load status, which can additionally update the IRD-based status of the items contained with the load.

In some cases, this process can include receiving tracking data from a plurality of shipping containers, each shipping container containing at least one of the items. These shipping containers can include vehicles such as trucks, rail cars, and ships that may have global positioning data (GPS) or route data reported. These shipping containers can include boxes, bins, bags, or pallets that include bar codes, wireless data tags, or other technology used to generate tracking information. As the various types of shipping have different real-world capabilities and options (e.g., trucks can unload at a store, but boats are unlikely to) data for each type of container can be configured to reflect those real world capabilities and options. As such, data for different containers may be handled differently by the systems.

Readiness metrics are produced 218. For example, for each item of the order discussed in this example, the computer system can generate an inventory readiness metric based on the item's travel based on tracking data for the item as the item travels from the item's respective source location to the respective destination location. For example, the computer system can compare actual departure events and actual arrival events to the planned arrival date 204 and the planned departure date 206.

In one example, items that actually depart or arrive before their planned dates can be tagged as “ahead of schedule”, items that actually depart or arrive on their planned dates can be tagged as “on schedule”, and items that actually depart or arrive after their planned dates can be tagged as “behind schedule.” In another example, the metric can report a risk of being behind schedule. Items with actual dates ahead of or on the planned dates can be tagged as low risk, items with actual dates behind the planned dates may be marked as “low risk” of missing their IRD, representing the supply chain's flexibility to expedite some items when needed, and items with actual dates more than a day after their planned dates can be marked as “high risk” of missing their IRD.

As tracking events are received, the computer system can continually update the IRD metrics. For example, a particular item may have an actual departure date matching the planned departure date 206. The rail car carrying the item may be delayed in transit, taking four days to travel instead of the planned two, resulting in an actual arrival date that is two days after the planned arrival date 204. In such a case, the item may initially be given an “on time”, “green” or otherwise favorable IRD metric. However, when the arrival date lapses (or when another intermediate date lapses), the computer system can update the readiness metric for that item to “late”, “red”, or otherwise unfavorable.

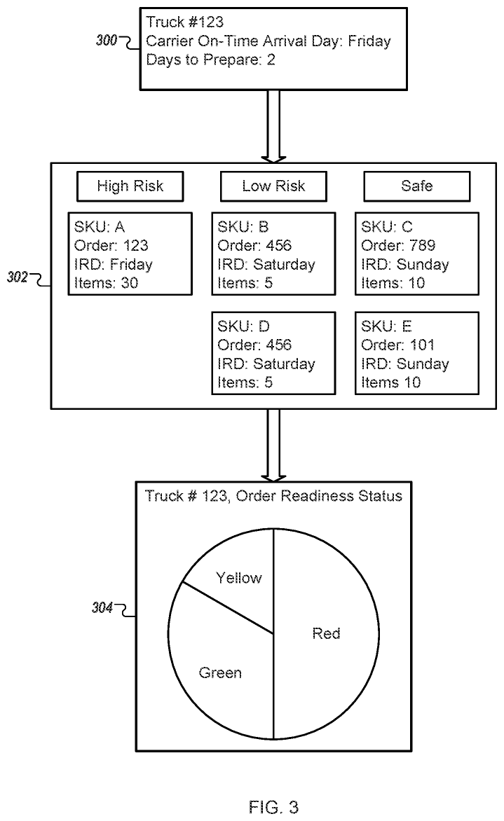

FIG. 3 shows a schematic diagram of an example readiness metric. In this example, the metric can report a risk of being behind schedule. Items with actual dates ahead of or on the planned dates can be tagged as a “safe” risk level, items with actual dates behind the planned dates may be marked as “low risk” of missing their IRD, representing the supply chain's flexibility to expedite some items when needed, and items with actual dates more than a day after their planned dates can be marked as “high risk” of missing their IRD.

Data 300 can be stored by a computer system to record data related to a container that is used to ship items for an order. For example, items for the order may be recorded as in transit on truck #123. The carrier may have a carrier-scheduled on-time arrival date of Friday. However, as explained above, this date may be different from the IRD or other intermediate dates used to determine IRD metrics. In addition, the data 300 can record the number of days needed to unpack and make ready the items once they reach their destination.

Data 302 can be stored by the computer system to maintain the IRD status of items in the truck #123. In this example, the truck is carrying a total of 60 items across five Stock Keeping Units (SKUs). These 60 items are each assigned to one of four orders, but have been shipped in the truck #123 to enhance overall efficiency of the supply chain. Because they are part of different orders, they may have assigned different IRDs. As such, items from the same truck—a truck that the carrier identifies as “on time”—can nevertheless have different IRD metrics. In this case, items with an IRD of Friday are more than a day behind schedule and marked as “high risk”, items a day behind schedule are marked as “at risk”, while items on schedule are marked as “safe”.

Report 304 reports the risk status of the items in the truck in the form of a multi-factor metric that represents the inventory readiness metric of each item contained by the container. Of note, the pie chart of the report 304 reports risk weighted by item count, not by SKU. So while there are five SKUs in the truck, one SKU contains half of the items and those items are at risk. As such, the pie chart shows half of the area marked “red” for “high risk”. Similarly, “low risk” and “safe” have the same number of SKUs but different numbers of items, and thus the “yellow” and “green” areas are of unequal size.

The report 304 may be displayed to a user on a screen, by being printed on paper, etc. With this information, the user can quickly identify the status of the items in the truck and determine if any remedial action should be taken. For example, as this report contains large amounts of red followed by yellow, the user may identify it as a high-priority for redial action. As such, the user may generate an order for the supply chain to expedite the truck #123.

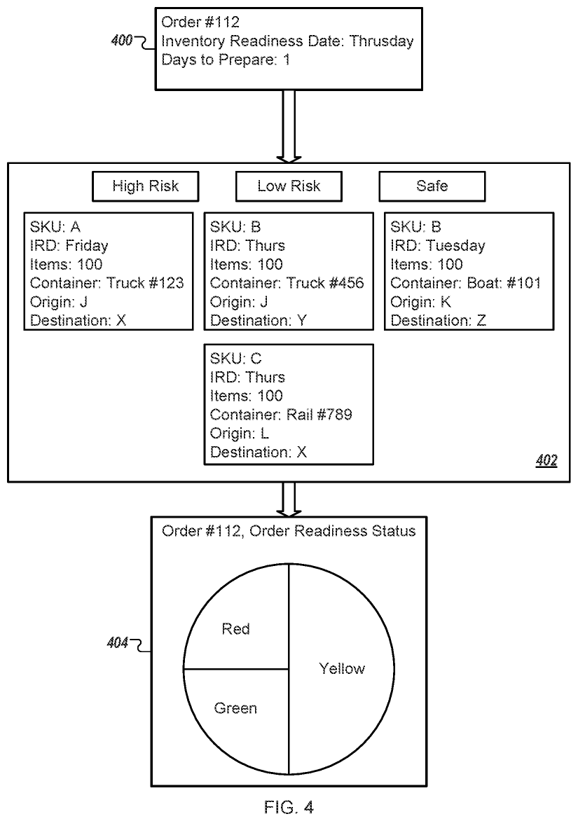

FIG. 4 shows a schematic diagram of an example readiness metric. In this example, the metric can report a risk of being behind schedule. Items with actual dates ahead of or on the planned dates can be tagged as a “safe” risk level, items with actual dates behind the planned dates may be marked as “low risk” of missing their IRD, representing the supply chain's flexibility to expedite some items when needed, and items with actual dates more than a day after their planned dates can be marked as “high risk” of missing their IRD.

Data 400 can be stored by a computer system to record data related to items for an order across many containers. For example, items for the order #112 may be recorded with associated metadata. For example, the data 400 can record the IRD for an order and number of days needed to unpack and make ready the items once they reach their destination.

Data 402 can be stored by the computer system to maintain the IRD status of items in the order #112. In this example, 400 items are being transported from various sources, to various destinations, as grouped together by three different SKUs of items (A, B, and C) being transported from three different origin locations (J, K, and L) to three different destinations (X, Y, and Z across four different containers, truck #123, truck #456, rail car #789, and boat #101. As depicted by the combinations of SKU, source location, destination location, and containers that are part of order #112, an order can include multiple different items (e.g., SKUs A, B, and C) that are fulfilled from multiple different source locations (e.g., origins J, K, and L) to multiple different destination locations (e.g., destinations X, Y, and Z) using multiple different carriers (e.g., truck #123, truck #456, rail car #789, and boat #101). Due to this complexity, simply tracking the progress of each of portion of an order is a challenge, let alone the added difficulty in assessing the overall and current IRD-based risk of the order (and its component parts) being unavailable across all of these different moving parts (e.g., different SKUs, source locations, destinations, containers). For example, because each items that is part of the order (represented by SKUs) may be at different points in its transit path, they may have assigned different statuses. As items transition along their transit path, which may include being transferred between different containers, the status of the items and their projection relative to IRD can be updated (e.g., events identifying progress of items can be received and used to update IRD-based status for items). As such, items set to arrive at least a day before the IRD are set to “safe”, items set to arrive on the IRD date are marked “low risk”, and items arriving after the IRD date are marked as “high risk”. Other rating schemes may be used.

Report 404 reports the risk status of items in the order in the form of a first multi-factor metric that represents the inventory readiness metric of each item of the order. Of note, the pie chart of the report 404 reports risk weighted by item count, not by container. However, in this case, each container contains the same number of items, so the size of each section of the chart happens to correlate to the number of containers in each risk category.

The report 404 may be displayed to a user on a screen, by being printed on paper, etc. With this information, the user can quickly identify the status of the items in the order and determine if any remedial action should be taken. For example, as this report contains large amounts of red followed by yellow, the user may identify it as a high-priority for redial action. As such, the user may generate an order for the supply chain to temporarily halt activities that use many of the items in the order #112.

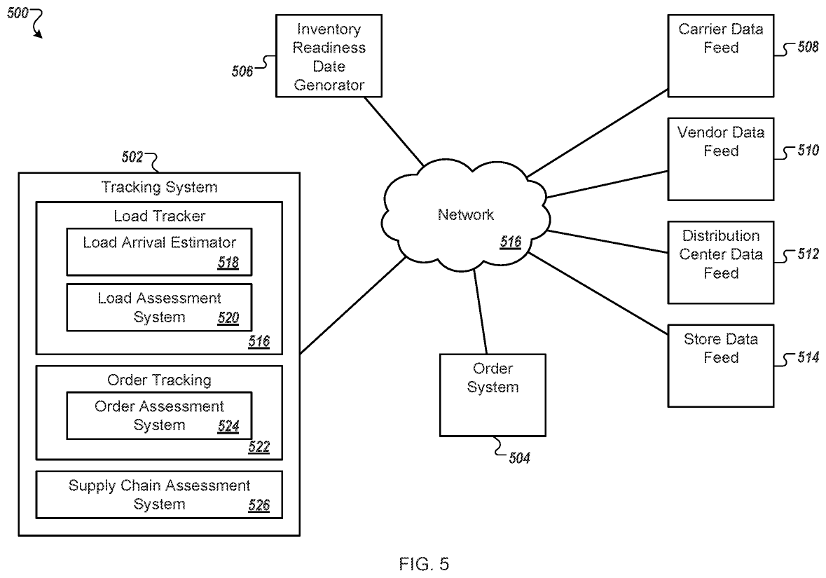

FIG. 5 shows a diagram of a system 500 that includes computer devices that operate to generate inventory readiness metrics. In the system 500, a tracking system 502 can receive data from other elements of the system 500 and can generate new data to report on the status of the supply chain. For example, an order system 504 can report, to the tracking system 502, details about orders that are to be fulfilled using the supply chain. This order information can include a listing of items in the order, sources for the items, destinations for the items, etc. An inventory readiness date generator 506 can generate, from the order information and other data in the system 500, inventory readiness dates for the orders.

Various data feeds can supply data to the tracking system 502 on an ongoing basis. A carrier data feed 508 can supply the tracking system 502 with carrier tracking data. This data can include shipping events (e.g., departure from a particular location by a particular container), status data (e.g., geolocation data, speed, direction, fuel status), and carrier-based-status values (e.g., on time, ahead of schedule, or late, according to carrier quality of service agreements).

A vendor data feed 510 can supply the tracking system 502 with vendor tracking data. This data can include vendor events (e.g., sale of items that are ordered), status data (e.g., where items are in the manufacturing process), and vendor-based-status values (e.g., if the manufacturing process is on time, ahead of schedule, or late, according to vendor contracts). A distribution center data feed 512 can supply the tracking system 502 with distribution center tracking data. This data can include information about the status of items in the distribution center (e.g., including both items that were ordered as part of the orders discussed above and items not ordered as discussed), and the capabilities of the distribution center (e.g., time to unload items, ability to sort and assemble parts). A store data feed 514 can supply the tracking system 502 with store tracking data. This data can include information about the status of items arriving and for sale at stores, and the capabilities of the stores (e.g., time to unload items, ability to sort and assemble parts).

A network 516 can provide data communication between elements of the system 500. For example, the data network can create, maintain, and tear down data connections that allow messages to be sent by one element and received by another element. The network 516 can include the Internet, private networks, public networks, etc.

The tracking system 502 can include a load tracker 516 that is able to execute operations to track loads of items. For example, the load tracker 516 may maintain, in computer memory, a list of loads in containers. This list of containers can also include, for each container, a list of items in the load, the order number of the items, the locations of the containers, etc. A load arrival estimator 518 can execute operations to estimate arrival times of loads. For example, the load estimator 518 may maintain, in computer memory, a list of planned arrival dates (e.g., arrival dates 204) for each load being tracked. The load estimator 518 may also store other data to determine if the loads being tracked are likely to meet their planned arrival dates. For example, this data may include intermediate benchmarks, geolocation data, travel velocity, traffic data, weather data, etc. This other data may be submitted to a classifier to identify one or more likely arrival dates.

A load assessment system 520 may submit this other data (e.g., the intermediate benchmarks, geolocation data, travel velocity, traffic data, weather data, etc.) to one or more classifier functions that return one or more estimated arrival dates, given the input. This estimated date may take the form of a single date estimated to be the most likely, a plurality of dates each having an associated confidence value, etc.

The tracking system 502 can include an order tracking system 522 that is able to execute operations to track orders of items. For example, the order tracker may maintain, in computer memory, a list of orders of items. This list of orders can also include, for each order, a list of containers containing items of the order, SKUs of the items, etc. A order assessment system 524 may submit data received from the load tracker 516 (e.g., estimated arrival times) to one or more classifier functions that return one or more order risk scores that report the risk each item of the order has of missing its assigned IRD.

A supply chain assessment system 526 of the tracking system 502 can generate assessments of the supply chain. For example, the system 526 can generate the screens 112 and 124, the report 304, and or the report 404.

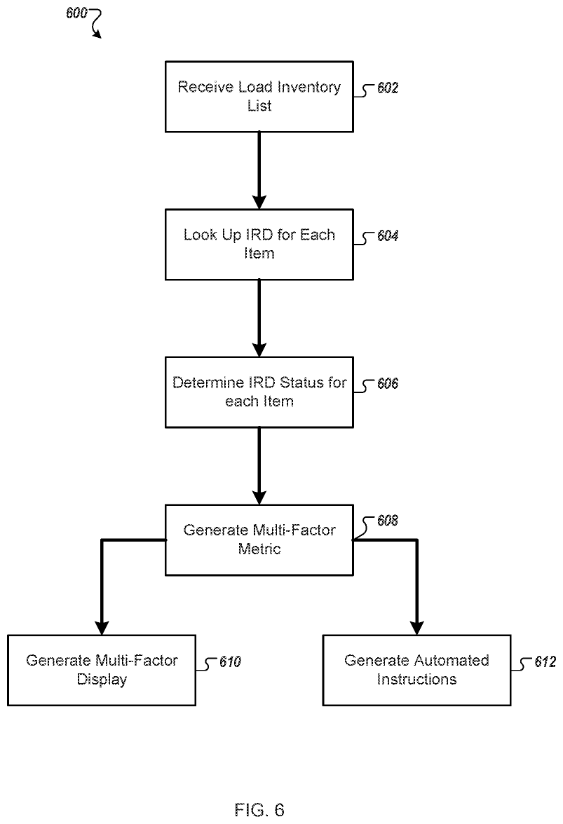

FIG. 6 shows a flowchart of a process 600 for tracking inventory readiness metrics for a container of items. For example, the process 600 can be performed by the tracking system 502. Therefore, the process 600 will be described with reference to the system 500. The process 600 may be performed, for example, after a new order has been received and IRDs have been set for the items contained within the order.

A load inventory list is received 602. For example, the load tracking system 502 can receive, from the vendor data feed 510, a file listing all items that are packaged into a single pallet on a truck. Additionally or alternatively, the load tracking system 502 can receive, from the carrier data feed 508, a file listing all items that are on a truck. The load tracker 518 can update, in computer memory, data related to each of these items to specify that the item is associated with the truck.

IRDs for each item of the inventory list are looked up 604. The load assessment system 520 can listen for updates in the computer memory. When the new load information is created in 602, the load assessment system 520 can access IRD dates for each item from the IRD generator 506, as well as other data such as intermediate dates, etc.

An IRD status for each item is determined 606. The load assessment system 520 can compare the status of each item in the load against the next upcoming date (e.g., intermediate date, delivery date) to determine the length of time (e.g., in days, hours, minutes, and/or seconds) available to meet the next upcoming date. The load assessment system 520 may supply this information to a classifier that takes, for example, the length of time and other related data to produce an IRD status. The status may take the form of a risk value, a risk classification, an expected delay value, etc.

A multi-factor metric for the load is generated 608. For example, the multi-factor metric may record, for each item in the load, the items IRD status. This recording may aggregate the statuses (e.g., a count of each status value, a summation of delay values) or may keep the statuses individual.

A multi-factor display is generated 610. For example, one or more GUI screens or static reports may be generated to display the multi-factor metric of IRD for the single load. This may take the form of a pie chart, bar chart, overall risk value, etc.

Automated instructions are generated 612. For example, computer instructions can be assembled from template instructions to alter the function of the supply chain. These instructions may be transmitted by data network to one or more automated systems that can operate on the instructions. These instructions may be structured in a way that improves the IRD risk of one or more items, or of the supply chain in total. For example, a load may be expedited to hop to the front of an unloading queue at a dock or loading bay.

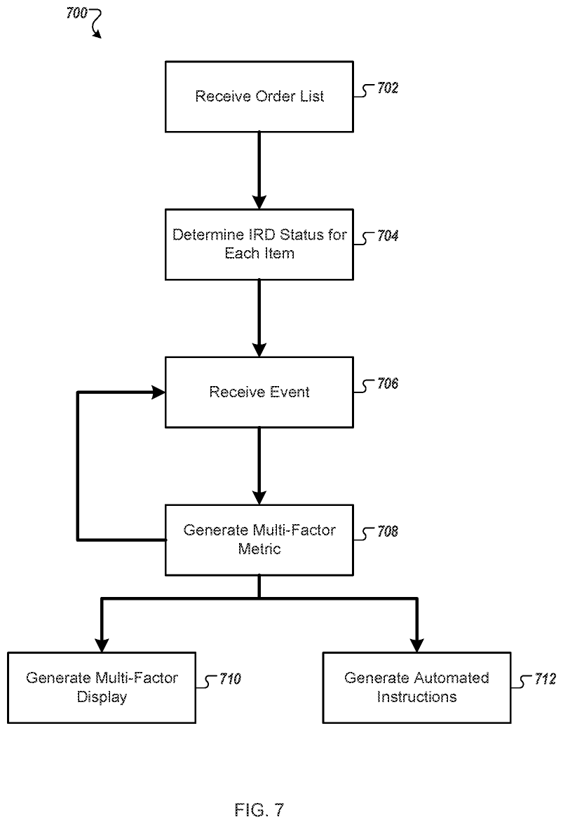

FIG. 7 shows a flowchart of an example process 700 for tracking inventory readiness metrics for an order of items. For example, the process 700 can be performed by the tracking system 502 after performing the process 600. Therefore, the process 700 will be described with reference to the system 500.

An order list is received 702. For example, the load tracking system 502 can receive, from the order system 504, a file listing all items specified by a single order. Additionally or alternatively, the order tracking system 522 can receive, from other data sources, a list of all loads that specify items in the load. From this complete list of loads, order may be assembled by combining items with similar order characteristics. The order tracking system 522 can store this order tracking information in computer memory.

An IRD status for each item is initially determined up 704. The order assessment system 524 can listen for updates in the computer memory. When a new order list is created in 702, the order assessment system 524 can access IRD dates for each item from the IRD generator 506, as well as other data such as intermediate dates, etc. The order assessment system 524 can compare the status of each item in the order against the next upcoming date (e.g., intermediate date, delivery date) to determine the length of time (e.g., in days, hours, minutes, and/or seconds) available to meet the next upcoming date. The order assessment system 524 may supply this information to a classifier that takes, for example, the length of time and other related data to produce an IRD status. The status may take the form of a risk value, a risk classification, an expected delay value, etc.

Events can be listened for, and when a new event is received 706, multi-factor metric for the order is generated 708. When new events (e.g., GPS location updates, arrivals, departures, damage to a load), IRDs related to that event may be updated. For example, when a load's location is updated, that location is compared to a location estimate and the IRDs of the load can be adjusted as needed. The multi-factor metric may record, for each item in the order, the items IRD status. This recording may aggregate the statuses (e.g., a count of each status value, a summation of delay values) or may keep the statuses individual.

A multi-factor display is generated 710. For example, one or more GUI screens or static reports may be generated to display the multi-factor metric of IRD for the single order. This may take the form of a pie chart, bar chart, overall risk value, etc.

Automated instructions are generated 712. For example, computer instructions can be assembled from template instructions to alter the function of the supply chain. These instructions may be transmitted by data network to one or more automated systems that can operate on the instructions. These instructions may be structured in a way that improves the IRD risk of one or more items, or of the supply chain in total. For example, a load may be expedited to hop to the front of an unloading queue at a dock or loading bay.

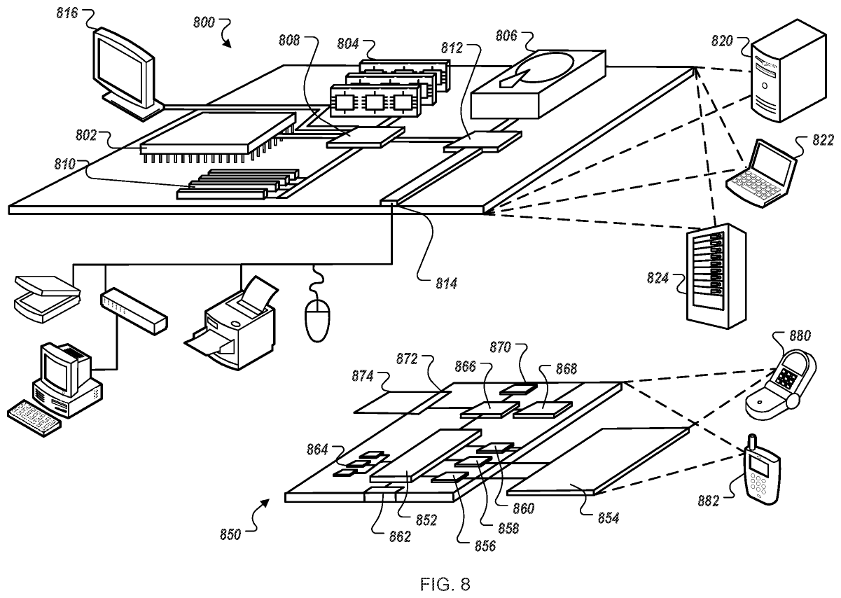

FIG. 8 shows an example of a computing device 800 and an example of a mobile computing device that can be used to implement the techniques described here. The computing device 800 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this document.

The computing device 800 includes a processor 802, a memory 804, a storage device 806, a high-speed interface 808 connecting to the memory 804 and multiple high-speed expansion ports 810, and a low-speed interface 812 connecting to a low-speed expansion port 814 and the storage device 806. Each of the processor 802, the memory 804, the storage device 806, the high-speed interface 808, the high-speed expansion ports 810, and the low-speed interface 812, are interconnected using various busses, and can be mounted on a common motherboard or in other manners as appropriate. The processor 802 can process instructions for execution within the computing device 800, including instructions stored in the memory 804 or on the storage device 806 to display graphical information for a GUI on an external input/output device, such as a display 816 coupled to the high-speed interface 808. In other implementations, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system).

The memory 804 stores information within the computing device 800. In some implementations, the memory 804 is a volatile memory unit or units. In some implementations, the memory 804 is a non-volatile memory unit or units. The memory 804 can also be another form of computer-readable medium, such as a magnetic or optical disk.

The storage device 806 is capable of providing mass storage for the computing device 800. In some implementations, the storage device 806 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product can also contain instructions that, when executed, perform one or more methods, such as those described above. The computer program product can also be tangibly embodied in a computer- or machine-readable medium, such as the memory 804, the storage device 806, or memory on the processor 802.

The high-speed interface 808 manages bandwidth-intensive operations for the computing device 800, while the low-speed interface 812 manages lower bandwidth-intensive operations. Such allocation of functions is exemplary only. In some implementations, the high-speed interface 808 is coupled to the memory 804, the display 816 (e.g., through a graphics processor or accelerator), and to the high-speed expansion ports 810, which can accept various expansion cards (not shown). In the implementation, the low-speed interface 812 is coupled to the storage device 806 and the low-speed expansion port 814. The low-speed expansion port 814, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 800 can be implemented in a number of different forms, as shown in the figure. For example, it can be implemented as a standard server 820, or multiple times in a group of such servers. In addition, it can be implemented in a personal computer such as a laptop computer 822. It can also be implemented as part of a rack server system 824. Alternatively, components from the computing device 800 can be combined with other components in a mobile device (not shown), such as a mobile computing device 850. Each of such devices can contain one or more of the computing device 800 and the mobile computing device 850, and an entire system can be made up of multiple computing devices communicating with each other.

The mobile computing device 850 includes a processor 852, a memory 864, an input/output device such as a display 854, a communication interface 866, and a transceiver 868, among other components. The mobile computing device 850 can also be provided with a storage device, such as a micro-drive or other device, to provide additional storage. Each of the processor 852, the memory 864, the display 854, the communication interface 866, and the transceiver 868, are interconnected using various buses, and several of the components can be mounted on a common motherboard or in other manners as appropriate.

The processor 852 can execute instructions within the mobile computing device 850, including instructions stored in the memory 864. The processor 852 can be implemented as a chipset of chips that include separate and multiple analog and digital processors. The processor 852 can provide, for example, for coordination of the other components of the mobile computing device 850, such as control of user interfaces, applications run by the mobile computing device 850, and wireless communication by the mobile computing device 850.

The processor 852 can communicate with a user through a control interface 858 and a display interface 856 coupled to the display 854. The display 854 can be, for example, a TFT (Thin-Film-Transistor Liquid Crystal Display) display or an OLED (Organic Light Emitting Diode) display, or other appropriate display technology. The display interface 856 can comprise appropriate circuitry for driving the display 854 to present graphical and other information to a user. The control interface 858 can receive commands from a user and convert them for submission to the processor 852. In addition, an external interface 862 can provide communication with the processor 852, so as to enable near area communication of the mobile computing device 850 with other devices. The external interface 862 can provide, for example, for wired communication in some implementations, or for wireless communication in other implementations, and multiple interfaces can also be used.

The memory 864 stores information within the mobile computing device 850. The memory 864 can be implemented as one or more of a computer-readable medium or media, a volatile memory unit or units, or a non-volatile memory unit or units. An expansion memory 874 can also be provided and connected to the mobile computing device 850 through an expansion interface 872, which can include, for example, a SIMM (Single In Line Memory Module) card interface. The expansion memory 874 can provide extra storage space for the mobile computing device 850, or can also store applications or other information for the mobile computing device 850. Specifically, the expansion memory 874 can include instructions to carry out or supplement the processes described above, and can include secure information also. Thus, for example, the expansion memory 874 can be provide as a security module for the mobile computing device 850, and can be programmed with instructions that permit secure use of the mobile computing device 850. In addition, secure applications can be provided via the SIMM cards, along with additional information, such as placing identifying information on the SIMM card in a non-hackable manner.

The memory can include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer- or machine-readable medium, such as the memory 864, the expansion memory 874, or memory on the processor 852. In some implementations, the computer program product can be received in a propagated signal, for example, over the transceiver 868 or the external interface 862.

The mobile computing device 850 can communicate wirelessly through the communication interface 866, which can include digital signal processing circuitry where necessary. The communication interface 866 can provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication can occur, for example, through the transceiver 868 using a radio-frequency. In addition, short-range communication can occur, such as using a Bluetooth, WiFi, or other such transceiver (not shown). In addition, a GPS (Global Positioning System) receiver module 870 can provide additional navigation- and location-related wireless data to the mobile computing device 850, which can be used as appropriate by applications running on the mobile computing device 850.

The mobile computing device 850 can also communicate audibly using an audio codec 860, which can receive spoken information from a user and convert it to usable digital information. The audio codec 860 can likewise generate audible sound for a user, such as through a speaker, e.g., in a handset of the mobile computing device 850. Such sound can include sound from voice telephone calls, can include recorded sound (e.g., voice messages, music files, etc.) and can also include sound generated by applications operating on the mobile computing device 850.

The mobile computing device 850 can be implemented in a number of different forms, as shown in the figure. For example, it can be implemented as a cellular telephone 880. It can also be implemented as part of a smart-phone 882, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

What is claimed is:

1. A system for the management of data, the system comprising:
one or more processors; and
computer-readable memory storing instructions that, when executed by the processors, cause the processors to perform operations comprising:
receiving an inventory readiness date that specifies a first calendar date on which an order of items should be ready at each items' respective destination location;
determining, for each item of the order, an arrival date before the readiness date, the arrival date specifying a second calendar date on which the item should arrive at the item's respective destination location;
determining, for each item of the order, a departure date before the arrival date, the departure date specifying a third calendar date on which the item should depart the item's respective source location; and
generating, for each item of the order, an inventory readiness metric based on the item's travel based on tracking data for the item as the item travels from the item's respective source location to the respective destination location.

2. The system of claim 1, wherein the operations further comprise:
receiving input from outside of the system that specifies the inventory readiness date.

3. The system of claim 2, wherein determining, for each item of the order, an arrival date and determining, for each item of the order, a departure date, comprises querying a user for the second calendar date and the third calendar date.

4. The system of claim 1, wherein generating, for each item, an inventory readiness metric comprises:
receiving tracking data from a plurality of shipping containers, each shipping container containing at least one of the items;
determining, for each item, the item's inventory readiness metric by comparing the tracking data of the shipping container containing the item to at least one of the group consisting of i) the item's arrival date; and ii) the items departure date.

5. The system of claim 1, wherein the operations further comprise:
generating, for the order of items, a first multi-factor metric that represents the inventory readiness metric of each item of the order; and
presenting, to a user of the system, a graphical representation of the first multi-factor metric.

6. The system of claim 5, wherein the operations further comprise:
generating, for a container containing items of the order as well as items of other orders, a second multi-factor metric that represents the inventory readiness metric of each item contained by the container; and
presenting, to a user of the system, a graphical representation of the second multi-factor metric.

7. The system of claim 6, wherein a single item of the order of items contributes the same status to the first multi-factor metric and to the second multi-factor metric.

8. The system of claim 1, wherein the operations further comprise updating the inventory readiness metrics as updated tracking data is received.

9. The system of claim 1, wherein a difference between the first calendar date and the second calendar date is determined based on capabilities of the destination location for the item.

10. The system of claim 1, wherein a difference between the second calendar date and the third calendar date is determined based on capabilities of a shipping duration for a container of the item.

11. A method for the management of data, the method comprising:
receiving an inventory readiness date that specifies a first calendar date on which an order of items should be ready at each items' respective destination location;
determining, for each item of the order, an arrival date before the readiness date, the arrival date specifying a second calendar date on which the item should arrive at the item's respective destination location;
determining, for each item of the order, a departure date before the arrival date, the departure date specifying a third calendar date on which the item should depart the item's respective source location; and
generating, for each item of the order, an inventory readiness metric based on the item's travel based on tracking data for the item as the item travels from the item's respective source location to the respective destination location.

12. The method of claim 11, wherein the method further comprise:
receiving input from outside of a system that specifies the inventory readiness date.

13. The method of claim 12, wherein determining, for each item of the order, an arrival date and determining, for each item of the order, a departure date, comprises querying a user for the second calendar date and the third calendar date.

14. The method of claim 11, wherein generating, for each item, an inventory readiness metric comprises:
receiving tracking data from a plurality of shipping containers, each shipping container containing at least one of the items;
determining, for each item, the item's inventory readiness metric by comparing the tracking data of the shipping container containing the item to at least one of the group consisting of i) the item's arrival date; and ii) the items departure date.

15. The method of claim 11, wherein the method further comprise:
generating, for the order of items, a first multi-factor metric that represents the inventory readiness metric of each item of the order; and
presenting, to a user of a system, a graphical representation of the first multi-factor metric.

16. The method of claim 15, wherein the method further comprises:
generating, for a container containing items of the order as well as items of other orders, a second multi-factor metric that represents the inventory readiness metric of each item contained by the container; and
presenting, to a user of a system, a graphical representation of the second multi-factor metric.

17. The method of claim 16, wherein a single item of the order of items contributes the same status to the first multi-factor metric and to the second multi-factor metric.

18. The method of claim 11, wherein the method further comprise updating the inventory readiness metrics as updated tracking data is received.

19. The method of claim 11, wherein a difference between the first calendar date and the second calendar date is determined based on capabilities of the destination location for the item.

20. The method of claim 11, wherein a difference between the second calendar date and the third calendar date is determined based on capabilities of a shipping duration for a container of the item.
